(19) United States
(12) Patent Application Publication
(10) Pub. No.: US 2009/0271224 A1
(43) Pub. Date: Oct. 29, 2009

(54) METHODS, SYSTEMS, AND PRODUCTS FOR EFFICIENT ANNUITIZATION

(75) Inventor: Jeffrey S. Lange, New York, NY (US)

Correspondence Address: EDWARDS ANGELL PALMER & DODGE LLP, P.O. BOX 55874, BOSTON, MA, 02205, US

(73) Assignee: GUGGENHEIM PARTNERS, LLC, New York, NY (US)

(21) Appl. No.: 12/428,074

(22) Filed: Apr. 22, 2009

Related U.S. Application Data
(60) Provisional application No. 61/125,875, filed on Apr. 28, 2008.

(51) Int. Cl. G06Q 40/00

(52) U.S. Cl. 705/4; 705/36 R

(57) ABSTRACT

A method of creating a variable universal life anti-martingale immediate annuity (VULAMIA) including the steps of soliciting preferences from an annuitant for annuity income and timing of annuity income versus a risk of loss of an annuity purchase price from early death, determining an annuity cashflow start date and a rate of return to be paid on an annuity consideration premium upon death, structuring a variable universal life policy to act as a wrapper for a separate account used to purchase immediate annuities and a death benefit which provides the rate of return on the annuity consideration premium, receiving premium payments into a VULAMIA to purchase the variable universal life policy and the immediate annuities, reinvesting immediate annuity payments until a predetermined payout date; and at death of the annuitant, providing a death benefit and the predetermined rate of return on the annuity consideration premiums.

### CROSS-REFERENCE TO RELATED APPLICATION

This application claims priority to U.S. Provisional Patent Application No. 61/125,875, filed Apr. 28, 2008, which is incorporated herein by reference.

### BACKGROUND OF THE INVENTION

1. Field of Invention

The present disclosure generally relates to a method and system for providing annuitized cashflows. In one embodiment, the present technology relates to a method or a system designed to replicate or mimic the cashflows and tax advantages of fixed and immediate annuities issued by insurance companies using banking products such as certificate of deposits. The result is a cashflow stream issued by a bank to a bank depositor, which has lower credit risk to the individual customer, lower cost of distribution, better liquidity, and superior after tax returns as compared to traditional annuities. In another embodiment, a superior flow of annuitized cashflows is obtained by investing in immediate annuities inside a variable separate account of a life insurance policy and then reinvesting a portion or all of each immediate annuity payment each period for a specified period of time.

2. Background

By the year 2030, the number of 65 year old people in the United States will increase to 70 million or even more. Due to a variety of factors such as increased longevity, inadequate retirement savings, stresses on federal provision of old age benefits under Social Security and Medicare, and other factors, the risk that a large percentage of retired persons will outlive their retirement incomes is substantial. There are a number of ways retirees can mitigate this risk. One increasingly common way retirees are lowering the risk of outliving their resources is taking out a reverse mortgage.

Reverse mortgage loans provide a lump sum, credit line, or monthly payment to borrowers. The loans are secured against a first mortgage deed on the home. Unlike traditional mortgage loans, current interest or principal payments are not required and the credit quality of the borrower, as measured, for example, by a FICO score, is not relevant to underwriting of the loan. The loan is asset-based only, i.e., secured non-recourse against the property. Interest accrues and is compounded at the loan rate. As the debt balance grows, the loan to value (LTV) ratio typically increases over time, with the expectation that the last borrower will either move, die, or vacate the home for a period longer than 12 months before the LTV ratio exceeds one, at which point the lender begins to suffer losses.

As a result, the reverse mortgage allows a retiree to access accumulated home equity with no personal recourse to the retiree and also a permanent right to remain in the home. While most reverse mortgages allow for unused portions of the line of credit provided to grow over time (e.g., at 5% or the loan rate) and guarantee a permanent tenure in the home, the prior art reverse mortgage loans do not directly address the need for annuitization, i.e., an explicit risk mitigation related to the increased needs that result from greater longevity.

Thus, a second way in which retirees can mitigate retirement shortfall risk is to annuitize a portion of their wealth. At retirement ages, proper annuitization is achieved using life insurance products which provide for guaranteed income streams, sometimes protected for inflation, which the annuitant cannot outlive. Such products are known as a single premium immediate annuity (SPIA). A SPIAs can be fixed or, in some cases, variable.

For example, a SPIA for a 70 year old male may pay $10,000 per annum per $100,000 of annuity premium while the annuitant is alive. Should the annuitant die (i.e., a so-called “life income” SPIA), the life income SPIA would pay nothing. SPIA's often provide various ways to alter the risk borne by the purchaser in the event of death. For example, a SPIA may offer payments for life or 20 years, whichever is greater or may provide for the refund of the single premium not yet paid out in annuity payments should the annuitant die relatively early. Variations to SPIAs have developed that mitigate the loss to the purchaser/annuitant upon death in return pay a lower periodic payment. For example, the same 70 year old might only receive $8,800 per annum should he elect for the option that refunds the balance of the premium upon death.

While directly addressing longevity risk, the annuity products such as SPIAs have a number of disadvantages. First, since SPIAs are insurance products, currently SPIAs can only be issued by insurance companies in the United States. Insurance companies are not federally chartered and are subject to regulation by each state in which they do business. Second, insurance products are not guaranteed by the federal government (unlike FDIC insured bank deposits) and are instead guaranteed in limited amounts by a purchaser (not company) by each state. Third, the cost of distribution of annuity products is high compared to bank products. Fourth, the taxation of annuities is complex. Fifth, annuities such as SPIAs are illiquid. While some products allow for early surrender or “commutation”, most do not. Thus, the secondary market for annuities is not liquid. Sixth, even though there is not a viable secondary market for annuities (for example, the buyer is always concerned about adverse selection, e.g., being sold annuities by unhealthy sellers), insurers must price the annuities to remain on the books until the death of the annuitant. This depresses the benefit that can be offered at inception.

### SUMMARY OF THE INVENTION

It is widely assumed that only a life insurer can provide the advantages of an annuity such as a SPIA. While it is true that only a life insurance company can legally issue an annuity product, in the year 1994, the Blackfeet National Bank in Montana attempted to offer a bank certificate of deposit which provided for annuitized withdrawals and ultimately failed. The advantages of an annuity such as a SPIA can be provided without providing an insurance product. The present technology provides such a product with enabling methods and systems, whereby a state or federally chartered bank can replicate the benefits of a traditional SPIA but without the disadvantages described above.

In one preferred embodiment of this technology, a bank deposit and bank loyalty program is described which provides the following advantages over an insurance company issued annuity: (1) deposit insurance under FDIC; (2) lower cost of distribution; (3) better tax treatment; and (4) better cost of funds for the issuing bank compared to that of an insurance company issuing an annuity.

State of the art SPIA's issued by life insurance and annuity companies are meant to provide income streams to purchasers with varying degrees of longevity insurance, i.e., protection against outliving the income stream provided in return for a lump sum premium. For example, consider a 70 year old male, a life income option SPIA might pay $9,400 per every $100,000 of single premium. An option of life income with refund of unpaid premium might pay the purchaser $8,400 per year for life.

The life income option has an exclusion ratio of 68.7% and the life income with refund option an exclusion ratio of 66.3%. The exclusion ratio refers to how much of the annual annuity payment is excluded from gross income as a return of principal. After the cumulative principal has been returned to the annuity purchaser, the entire annuity payment is taxable as ordinary income. Tables 1A and 1B below show the cashflows for each income option both before and after tax (assuming a total ordinary tax rate of 40%), where EOY stands for end of year.

TABLE 1A

| EOY | Life Income Only | | Life Income | |
|---|---|---|---|---|
| Age | (LIO) | AT LIO | Refund (LIR) | AT LIR |
| 71 | $9,400 | $8,223 | $8,400 | $7,268 |
| 72 | $9,400 | $8,223 | $8,400 | $7,268 |
| 73 | $9,400 | $8,223 | $8,400 | $7,268 |
| 74 | $9,400 | $8,223 | $8,400 | $7,268 |
| 75 | $9,400 | $8,223 | $8,400 | $7,268 |
| 76 | $9,400 | $8,223 | $8,400 | $7,268 |
| 77 | $9,400 | $8,223 | $8,400 | $7,268 |
| 78 | $9,400 | $8,223 | $8,400 | $7,268 |
| 79 | $9,400 | $8,223 | $8,400 | $7,268 |
| 80 | $9,400 | $8,223 | $8,400 | $7,268 |
| 81 | $9,400 | $8,223 | $8,400 | $7,268 |
| 82 | $9,400 | $8,223 | $8,400 | $7,268 |
| 83 | $9,400 | $8,223 | $8,400 | $7,268 |
| 84 | $9,400 | $8,223 | $8,400 | $7,268 |
| 85 | $9,400 | $8,223 | $8,400 | $7,268 |
| 86 | $9,400 | $6,970 | $8,400 | $7,268 |
| 87 | $9,400 | $5,640 | $8,400 | $7,268 |
| 88 | $9,400 | $5,640 | $8,400 | $5,138 |
| 89 | $9,400 | $5,640 | $8,400 | $5,040 |
| 90 | $9,400 | $5,640 | $8,400 | $5,040 |

TABLE 1B

| EOY | Life Income Only | | Life Income | |
|---|---|---|---|---|
| Age | (LIO) | AT LIO | Refund (LIR) | AT LIR |
| 91 | $9,400 | $5,640 | $8,400 | $5,040 |
| 92 | $9,400 | $5,640 | $8,400 | $5,040 |
| 93 | $9,400 | $5,640 | $8,400 | $5,040 |
| 94 | $9,400 | $5,640 | $8,400 | $5,040 |
| 95 | $9,400 | $5,640 | $8,400 | $5,040 |
| 96 | $9,400 | $5,640 | $8,400 | $5,040 |
| 97 | $9,400 | $5,640 | $8,400 | $5,040 |
| 98 | $9,400 | $5,640 | $8,400 | $5,040 |
| 99 | $9,400 | $5,640 | $8,400 | $5,040 |
| 100 | $9,400 | $5,640 | $8,400 | $5,040 |
| 101 | $9,400 | $5,640 | $8,400 | $5,040 |
| 102 | $9,400 | $5,640 | $8,400 | $5,040 |
| 103 | $9,400 | $5,640 | $8,400 | $5,040 |
| 104 | $9,400 | $5,640 | $8,400 | $5,040 |
| 105 | $9,400 | $5,640 | $8,400 | $5,040 |
| 106 | $9,400 | $5,640 | $8,400 | $5,040 |
| 107 | $9,400 | $5,640 | $8,400 | $5,040 |
| 108 | $9,400 | $5,640 | $8,400 | $5,040 |
| 109 | $9,400 | $5,640 | $8,400 | $5,040 |
| 110 | $9,400 | $5,640 | $8,400 | $5,040 |

Tables 1A and 1B arbitrarily show the cashflows only to age 110 for an annuitant originally aged 70. Column 1 shows the pre-tax cashflows that would be received upon survival for the life income only option for a single premium of $100,000. Column 2 shows the after tax cashflows assuming a total tax rate of 40%. Column 3 shows pre-tax cashflows for the life income option with cash refund to the beneficiary should the annuitant not live long enough for the single premium to be paid out. Column 4 shows the after tax cashflows corresponding to column 3.

There are three parties to an immediate annuity contract: the contract owner, the annuitant (e.g., the life against which the payment of cashflows is measured), and the payee. Most frequently, the annuitant is also the owner and the payee of the cashflows whereas the contract owner is typically the payor. For the payee, one relevant measure of the value of the annuity is the internal rate of return (IRR) to a given survival date, calculated both pre and post-tax beginning at end of the 5^{th} year as shown by Table 2 below.

TABLE 2

| | Life Income | | Life Income | |
|---|---|---|---|---|
| Age | Only (LIO) | AT LIO | Refund (LIR) | AT LIR |
| 75 | −20.84% | −23.81% | −23.35% | −26.41% |
| 76 | −14.26% | −17.09% | −16.65% | −19.56% |
| 77 | −9.49% | −12.17% | −11.75% | −14.51% |
| 78 | −5.93% | −8.47% | −8.08% | −10.69% |
| 79 | −3.22% | −5.63% | −5.26% | −7.74% |
| 80 | −1.11% | −3.41% | −3.05% | −5.42% |
| 81 | 0.56% | −1.64% | −1.29% | −3.56% |
| 82 | 1.90% | −0.20% | 0.12% | −2.04% |
| 83 | 3.00% | 0.97% | 1.28% | −0.80% |
| 84 | 3.89% | 1.94% | 2.24% | 0.23% |
| 85 | 4.64% | 2.75% | 3.04% | 1.10% |
| 86 | 5.26% | 3.33% | 3.71% | 1.83% |
| 87 | 5.79% | 3.74% | 4.28% | 2.46% |
| 88 | 6.24% | 4.11% | 4.77% | 2.84% |
| 89 | 6.62% | 4.43% | 5.19% | 3.18% |
| 90 | 6.95% | 4.71% | 5.55% | 3.49% |
| 91 | 7.23% | 4.97% | 5.86% | 3.76% |
| 92 | 7.48% | 5.19% | 6.13% | 4.00% |
| 93 | 7.69% | 5.40% | 6.37% | 4.22% |
| 94 | 7.88% | 5.58% | 6.58% | 4.41% |
| 95 | 8.04% | 5.74% | 6.76% | 4.59% |
| 96 | 8.18% | 5.88% | 6.93% | 4.75% |
| 97 | 8.31% | 6.01% | 7.07% | 4.89% |
| 98 | 8.42% | 6.13% | 7.20% | 5.02% |
| 99 | 8.52% | 6.24% | 7.32% | 5.14% |
| 100 | 8.61% | 6.33% | 7.42% | 5.25% |
| 101 | 8.69% | 6.42% | 7.51% | 5.35% |
| 102 | 8.76% | 6.50% | 7.59% | 5.44% |
| 103 | 8.82% | 6.57% | 7.67% | 5.52% |
| 104 | 8.88% | 6.63% | 7.73% | 5.60% |
| 105 | 8.93% | 6.69% | 7.79% | 5.66% |
| 106 | 8.97% | 6.75% | 7.85% | 5.73% |
| 107 | 9.01% | 6.80% | 7.90% | 5.78% |
| 108 | 9.05% | 6.84% | 7.94% | 5.84% |
| 109 | 9.08% | 6.88% | 7.98% | 5.89% |
| 110 | 9.11% | 6.92% | 8.02% | 5.93% |

In Table 2, LIO refers to “life income only” and LIR refers to “life income with cash refund.” A 40% total income tax rate is assumed. For simplicity, the deduction arising from unrecovered annuity basis is ignored. As can be seen, the refund feature costs the immediate annuity payee over 100 basis points in yield at age 89, which is approximately the life expectancy (LE) for a 70 year old male using the VBT 2001 select tables. It is noted that the VBT 2001 select table will impute longer life expectancies for annuitants than persons of the general population.

One aspect of the present technology is to provide a more efficient product which accomplishes an immediate annuity but also is more efficient in the sense that the payee receives a higher pre- and post-tax IRR and the issuing company enjoys a lower IRR or cost of liabilities (e.g., cost of funds) from issuing the annuity. In addition, it is another aspect of the present technology to provide a product design which can be issued by FDIC insured banks so that payees enjoy federal deposit insurance which is unavailable for annuities issued by state regulated insurance companies. In another version, the product accomplishes the important aims of a traditional immediate annuity or deferred annuity which then can be annuitized later without meeting the definition of an annuity (deferred or immediate) so that a bank issuing the product would not be subject to state insurance regulation.

The cost of funds to the issuing insurance company of the annuities described in Tables 1 and 2 can be computed using survivorship probabilities contained in the VBT 2001 select mortality tables. For example, the expected life only cashflows to the issuer can be computed by multiplying the life only cashflow in each year by the respective survivorship probability for a 70 year old from the aforementioned mortality table shown below as Tables 3A and 3B.

TABLE 3A

| EOY Age | LIO | Surv. Prob | Exp. LIO |
|---|---|---|---|
| 71 | $9,400 | 0.9960 | $9,362.78 |
| 72 | $9,400 | 0.9886 | $9,293.30 |
| 73 | $9,400 | 0.9785 | $9,198.23 |
| 74 | $9,400 | 0.9659 | $9,079.39 |
| 75 | $9,400 | 0.9521 | $8,949.65 |
| 76 | $9,400 | 0.9337 | $8,776.47 |
| 77 | $9,400 | 0.9134 | $8,585.76 |
| 78 | $9,400 | 0.8911 | $8,376.61 |
| 79 | $9,400 | 0.8646 | $8,127.24 |
| 80 | $9,400 | 0.8334 | $7,833.60 |

TABLE 3B

| EOY Age | LIO | Surv. Prob | Exp. LIO |
|---|---|---|---|
| 81 | $9,400 | 0.7971 | $7,493.00 |
| 82 | $9,400 | 0.7555 | $7,102.01 |
| 83 | $9,400 | 0.7088 | $6,662.68 |
| 84 | $9,400 | 0.6572 | $6,177.51 |
| 85 | $9,400 | 0.6010 | $5,649.64 |
| 86 | $9,400 | 0.5439 | $5,112.98 |
| 87 | $9,400 | 0.4865 | $4,573.20 |
| 88 | $9,400 | 0.4295 | $4,037.45 |
| 89 | $9,400 | 0.3733 | $3,508.67 |
| 90 | $9,400 | 0.3183 | $2,991.66 |
| 91 | $9,400 | 0.2665 | $2,504.74 |
| 92 | $9,400 | 0.2192 | $2,060.27 |
| 93 | $9,400 | 0.1769 | $1,662.83 |
| 94 | $9,400 | 0.1395 | $1,311.14 |
| 95 | $9,400 | 0.1078 | $1,013.73 |
| 96 | $9,400 | 0.0801 | $752.88 |
| 97 | $9,400 | 0.0583 | $547.73 |
| 98 | $9,400 | 0.0415 | $389.68 |
| 99 | $9,400 | 0.0288 | $270.61 |
| 100 | $9,400 | 0.0195 | $183.06 |
| 101 | $9,400 | 0.0128 | $120.35 |
| 102 | $9,400 | 0.0082 | $76.69 |
| 103 | $9,400 | 0.0050 | $47.24 |
| 104 | $9,400 | 0.0030 | $28.03 |
| 105 | $9,400 | 0.0017 | $15.97 |
| 106 | $9,400 | 0.0009 | $8.70 |
| 107 | $9,400 | 0.0005 | $4.51 |
| 108 | $9,400 | 0.0002 | $2.21 |
| 109 | $9,400 | 0.0001 | $1.02 |
| 110 | $9,400 | 0.0000 | $0.44 |

Continuing with the example where the immediate annuity is in the amount of $100,000, the expected IRR to the issuer is 4.722%. Since this is the cost of funds, the issuer prefers a lower cost of funds to a higher one. A comparable distribution cost for immediate annuities is about 3%. That is, the issuer really issues the cashflows for $97,000 since $3,000 goes to the insurance agent in this example rather than $100,000. When these costs are taken into account, the issuer IRR rises to 5.11% cost of funds.

In view of the above, it is an aspect of this technology to provide annuity and immediate annuity replicating cashflows to annuitants and payees at lower costs and/or higher internal rates of return.

It is another aspect of this technology to provide lower cost of funds to issuers of annuity and immediate annuity replicating cashflows.

It is another aspect of this technology to provide superior tax treatment for a new product which can replicate, either exactly or substantially, the cashflows of an annuity or immediate annuity.

It is another aspect of this technology to provide a new product which can be issued by FDIC insured depository banks, either state or federal charted banks or savings banks, without the bank and new product subject to state insurance regulation.

It is another aspect of this technology to provide an annuity and immediate annuity replicating bank depository product which can be offered nationally at low distribution cost to the issuing bank or thrift.

In one embodiment, the technology is directed to system or method for a federal bank, federal savings bank, state savings bank, or state bank certificate of deposit whereby a reverse mortgage is computed which: (1) reduces the probability of default for the borrower; and (2) minimizes expected tax costs to the borrower in the event of default; while (3) simultaneously maintaining a target profit to the lender.

It is another aspect of the present technology to provide annuitized cashflows which receive superior tax treatment to that of a traditional annuitized cashflows. In one embodiment, a contract owner (1) buys a separate account life insurance policy; (2) chooses a series of options specifying a preference for current income versus future income; (3) receives a managed separate account and a manager which implements the contract owner's preferences by investing the funds of the managed separate account in at least one immediate annuity; and (4) uses a martingale approach to reinvesting the immediate annuity payments to achieve the desired ratio of current versus future income.

In one aspect, the technology is directed toward providing a customer of a bank or thrift institution with a bank deposit which has a return increasing with the longevity of the depositor. The advantages of such a deposit include: (1) a stream of cashflows from the deposit to the customer which cannot be outlived; (2) FDIC insurance for principal per account up to $100,000; (3) greater distribution capability through bank branches and online banking systems as compared to traditional distribution of annuities by life insurance companies and their agents; and (4) a low cost and long duration funding source for banks and thrifts.

In another aspect, the technology is directed toward providing a novel life insurance product. Providing the life insurance product includes the steps of: (1) creating an Internal Revenue Code (“IRC”) compliant variable policy under section 7702; (2) soliciting the policy owner's or beneficiary's preference for annuity cashflows while alive and death benefit cashflows upon death; (3) receiving a lifetime HIPAA compliant medical authorization form from the measured life; (4) receiving one or more premiums from the variable policy owner; (5) investing all or a portion of the premiums in five or more immediate annuity contracts; (6) receiving the commission from the immediate annuity contracts; (7) subtracting from the cashflows derived from the immediate annuity contracts or from other assets in the variable policy separate account cost of insurance; (8) at each immediate annuity cashflow anniversary, determining whether the measured life has had a change in health; (9) reinvesting all or a portion of each immediate annuity cashflow in new immediate annuities; and (10) upon reaching a retirement date, distributing available immediate annuity cashflows preferably in the form of policy loans.

It should be appreciated that the subject technology can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

So that those having ordinary skill in the art to which the disclosed technology appertains will more readily understand how to make and use the same, reference may be had to the following drawings.

FIG. 1 is a block diagram depicting an embodiment of the present technology.

FIG. 2 is a flowchart for creating a bank issued replicated annuity certificate of deposit in accordance with the subject disclosure.

FIG. 3 is another flowchart for creating a variable universal life anti-martingale immediate annuity in accordance with the subject disclosure.

### DETAILED DESCRIPTION OF PREFERRED EMBODIMENTS

The present disclosure is described in relation to systems, methods, products and plans for providing efficient immediate annuities and like performing financial products. The advantages, and other features of the systems, products, plans, and methods disclosed herein, will become more readily apparent to those having ordinary skill in the art from the following detailed description of certain preferred embodiments taken in conjunction with the drawings which set forth representative embodiments of the present invention.

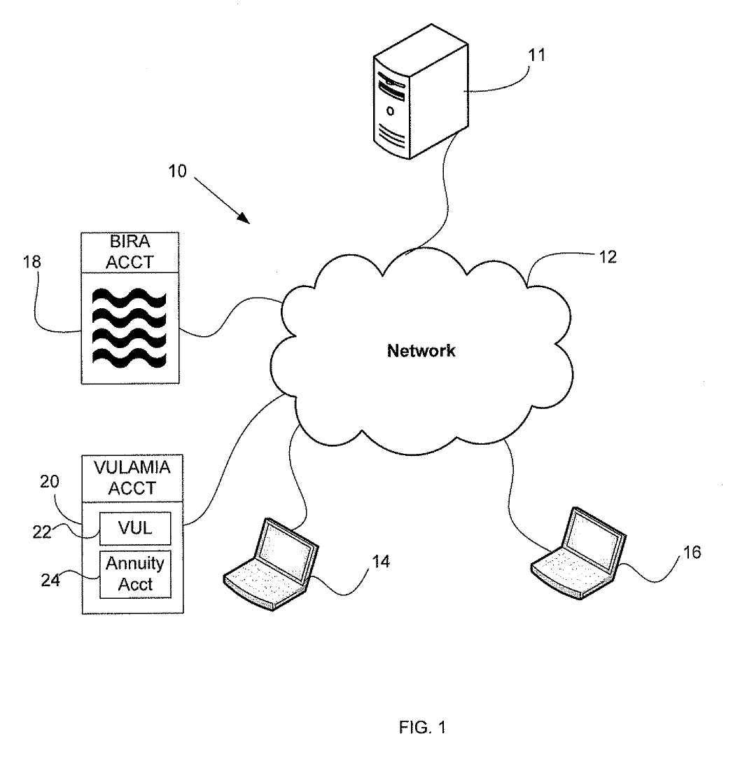

Referring now to the FIG. 1, there is shown a block diagram of an environment 10 with a financial system embodying and implementing the methodology of the present disclosure. The financial system inter connects users such as lenders, borrowers, brokers, agents, policy holders, companies (e.g., insurance companies and banks) and the like. The financial system also provides data and processing power. The financial system is user-interactive and may be self-contained so that users need not venture to another address within a distributed computing network to access various information and perform various tasks. The following discussion describes the structure of such an environment 10 but such discussion of the applications programs and data that embody the methodology of the present invention is not meant to limit the platform upon which the subject technology may be practiced.

The environment 10 includes one or more servers 11 which communicate with a distributed computer network 12 via communication channels, whether wired or wireless, as is well known to those of ordinary skill in the pertinent art. In a preferred embodiment, the distributed computer network 12 is the Internet. For simplicity, one server 11 is shown. Server 11 hosts multiple Web sites and houses multiple databases necessary for the proper operation of the financial system in accordance with the subject invention.

The server 11 is any of a number of servers known to those skilled in the art that are intended to be operably connected to a network so as to operably link to a plurality of clients 14, 16 via the distributed computer network 12. The plurality of computers or clients 14, 16 are desktop computers, laptop computers, personal digital assistants, cellular telephones and the like. The clients 14, 16 allow users to access information on the server 11. For simplicity, only two clients 14, 16 are shown. The clients 14, 16 have displays and an input device(s) as would be appreciated by those of ordinary skill in the pertinent art. The financial system is utilized to establish accounts in accordance with the subject technology. It is envisioned that the accounts can simply be data stored in a database that is reflective of deposits, withdrawals and like information. Such accounts may be stored in a plurality of locations although for simplicity the accounts are shown singularly and in communication with the network.

### Bank Issued Replicated Annuity Certificate of Deposit (BIRA CD)

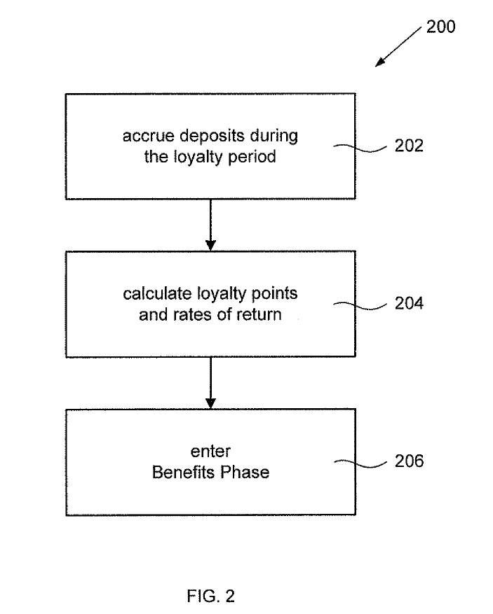

Referring to FIG. 2, a flowchart representing a method for the creation of bank issued replicated annuity (“BIRA”) certificate of deposit is shown and referred to generally by the reference numeral 200. A BIRA account is also shown in FIG. 1 and referred to generally by the reference numeral 18. The flow charts herein illustrate the structure or the logic of the present technology, possibly as embodied in computer program software for execution on a computer, digital processor or microprocessor in a network. Those skilled in the art will appreciate that the flow charts illustrate the structures of the computer program code elements, maybe even logic circuits on an integrated circuit, that function according to the present technology. As such, the present technology may be practiced by a machine component that renders the program code elements in a form that instructs a digital processing apparatus (e.g., computer) to perform a sequence of function steps corresponding to those shown in the flow charts.

Commonly, a state or federal thrift or bank issues a variety of savings, checking and certificate of deposit (CD) accounts. The banking institution can structure a savings program which provides a higher rate of return on invested funds should the depositor experience increased longevity. Such a program, called a BIRA program, provides depositor returns with an attractive liability cost to the issuing bank or thrift.

At step 202, a depositor makes one or a number of deposits over a period of time called the “loyalty period.” In the loyalty period, the depositor's funds are credited with interest rates that are comparable to “core” deposit rates associated with savings and checking accounts.

At step 204, the depositor receives loyalty points for the amount of deposits held at the bank at core deposit rates. For example, assume a 60 year old depositor deposits $50,000 at the bank in a checking account. The checking account pays interest of 1% while market certificate of deposits with a 1 year maturity pay 4%. In a preferred embodiment, the depositor is credited with 300 basis points (4% less 1% multiplied by 1 year) of loyalty credits.

The loyalty program specifies a future date whereby the depositor can begin to receive above markets rates of interest. The loyalty program specifies the year at which the depositor can convert to an annually renewable time CD. In a preferred embodiment, renewal can be automatic or can be at the election of the depositor. The renewable CD may have a put option at death of the amount invested or a fraction of this amount, such as 110% or some other percentage. The put option at death may be implemented with a “payable on death” (POD) feature to avoid probate. In a preferred embodiment, the annually renewable interest rate on the CD increases each year. As the depositor survives each year, the internal rate of return increases providing a form of insurance against longevity.

As an example of the BIRA, consider a 55 year old depositor. He agrees to the following terms of the BIRA:

### Loyalty Phase Years 1-15

Savings rate:
Years 1-5 @1%
Years 6-10 @2%
Years 11-15 @3%
   Benefits Phase Years 16 and following

### Benefits Phase Rates:

Years 16-20 @7%
Years 21-25 @10%
Years 26-30 @15%
Years 31-35 @20%
Years 36+@25%
   Each year that the BIRA customer renews his CD, he receives the indicated interest rate. For the above example, it is assumed that the 10 year swap rate is 4.5%. Thus, the BIRA CD pays interest below the 10 year swap rate for the first 15 years in this example. In later years in the above example, the BIRA pays higher than market interest.

At step 206, in these later years, or the “Benefits Phase,” the rate of interest can increase periodically (e.g., every year, every 5 years). Tables 4A and 4B below illustrate the actual cash flows and expected cash flows for a 55 year old BIRA depositor, per $100 of deposit amount. The second column “Haz rate” is the force of mortality for a select 55 year old for each year in the first column from the 2001 VBT Tobacco Distinct mortality table. The third column is the fraction of original 55 year olds surviving to the age in the first column. Columns 4 and 5, respectively, are the exemplary interest rate in rate and per $100 for the above example. Columns 6 is the expected interest rate per $100 which is the product of the survivorship probability from column 3 and the rate in dollars per $100 in column 5. Column 7 is the expected return of principal per $100 which is the product of $100 and the prior year's survivorship probability multiplied by the current year's force of mortality or “haz rate” in the second column. Column 8 is the total expected cash flow which is equal to the sum of columns 6 and 7.

TABLE 4A

| EOY | Haz | | Int | | | | |
|---|---|---|---|---|---|---|---|
| Age | Rate | Survive Rate | Rate | Interest | Ex Interest | Ex Principal | Ex Total |
| 56 | 0.00119 | 0.99881 | 1.0% | 1 | 0.99881 | 0.119 | 1.11781 |
| 57 | 0.00186 | 0.996952213 | 1.0% | 1 | 0.99695221 | 0.18577866 | 1.18273087 |
| 58 | 0.00246 | 0.994499711 | 1.0% | 1 | 0.99449971 | 0.245250244 | 1.23974996 |
| 59 | 0.00294 | 0.991575882 | 1.0% | 1 | 0.99157588 | 0.292382915 | 1.2839588 |
| 60 | 0.00344 | 0.988164861 | 1.0% | 1 | 0.98816486 | 0.341102103 | 1.32926696 |
| 61 | 0.00414 | 0.984073858 | 2.0% | 2 | 1.96814772 | 0.409100252 | 2.37724797 |
| 62 | 0.00511 | 0.979045241 | 2.0% | 2 | 1.95809048 | 0.502861742 | 2.46095222 |
| 63 | 0.00628 | 0.972896837 | 2.0% | 2 | 1.94579367 | 0.614840411 | 2.56063408 |
| 64 | 0.0075 | 0.96560011 | 2.0% | 2 | 1.93120022 | 0.729672628 | 2.66087285 |
| 65 | 0.00904 | 0.956871085 | 2.0% | 2 | 1.91374217 | 0.8729025 | 2.78664467 |
| 66 | 0.01034 | 0.946977038 | 3.0% | 3 | 2.84093112 | 0.989404702 | 3.83033582 |
| 67 | 0.01195 | 0.935660663 | 3.0% | 3 | 2.80698199 | 1.131637561 | 3.93861955 |
| 68 | 0.01352 | 0.923010531 | 3.0% | 3 | 2.76903159 | 1.265013216 | 4.03404481 |
| 69 | 0.01509 | 0.909082302 | 3.0% | 3 | 2.72724691 | 1.392822891 | 4.1200698 |
| 70 | 0.01685 | 0.893764265 | 3.0% | 3 | 2.68129279 | 1.531803678 | 4.21309647 |
| 71 | 0.01904 | 0.876746993 | 7.0% | 7 | 6.13722895 | 1.70172716 | 7.83895611 |
| 72 | 0.02152 | 0.857879398 | 7.0% | 7 | 6.00515579 | 1.88675953 | 7.89191532 |
| 73 | 0.02415 | 0.837161611 | 7.0% | 7 | 5.86013127 | 2.071778746 | 7.93191002 |
| 74 | 0.02715 | 0.814432673 | 7.0% | 7 | 5.70102871 | 2.272893773 | 7.97392248 |
| 75 | 0.03067 | 0.789454023 | 7.0% | 7 | 5.52617816 | 2.497865008 | 8.02404317 |
| 76 | 0.0343 | 0.76237575 | 10.0% | 10 | 7.6237575 | 2.707827298 | 10.3315848 |
| 77 | 0.03842 | 0.733085274 | 10.0% | 10 | 7.33085274 | 2.929047631 | 10.2599004 |
| 78 | 0.0432 | 0.70141599 | 10.0% | 10 | 7.0141599 | 3.166928382 | 10.1810883 |
| 79 | 0.04884 | 0.667158833 | 10.0% | 10 | 6.67158833 | 3.425715694 | 10.097304 |
| 80 | 0.05486 | 0.630558499 | 10.0% | 10 | 6.30558499 | 3.660033356 | 9.96561835 |
| 81 | 0.06945 | 0.586766211 | 15.0% | 15 | 8.80149317 | 4.379228777 | 13.1807219 |
| 82 | 0.07712 | 0.541514801 | 15.0% | 15 | 8.12272202 | 4.525141022 | 12.647863 |
| 83 | 0.08536 | 0.495291098 | 15.0% | 15 | 7.42936647 | 4.622370343 | 12.0517368 |
| 84 | 0.09449 | 0.448491042 | 15.0% | 15 | 6.72736563 | 4.680005583 | 11.4073712 |
| 85 | 0.10468 | 0.401543 | 15.0% | 15 | 6.02314499 | 4.694804227 | 10.7179492 |
| 86 | 0.11599 | 0.354968027 | 20.0% | 20 | 7.09936054 | 4.657497253 | 11.7568578 |
| 87 | 0.12832 | 0.30941853 | 20.0% | 20 | 6.1883706 | 4.554949724 | 10.7433203 |

TABLE 4B

| EOY | Haz | | Int | | | | |
|---|---|---|---|---|---|---|---|
| Age | Rate | Survive Rate | Rate | Interest | Ex Interest | Ex Principal | Ex Total |
| 88 | 0.14151 | 0.265632714 | 20.0% | 20 | 5.31265427 | 4.378581617 | 9.69123589 |
| 89 | 0.15538 | 0.224358703 | 20.0% | 20 | 4.48717405 | 4.127401106 | 8.61457516 |
| 90 | 0.16981 | 0.186260351 | 20.0% | 20 | 3.72520703 | 3.80983513 | 7.53504216 |
| 91 | 0.18319 | 0.152139318 | 25.0% | 25 | 3.80348294 | 3.412103377 | 7.21558632 |
| 92 | 0.19707 | 0.122157222 | 25.0% | 25 | 3.05393056 | 2.998209532 | 6.05214009 |
| 93 | 0.21163 | 0.096305089 | 25.0% | 25 | 2.40762723 | 2.585213295 | 4.99284053 |
| 94 | 0.22696 | 0.074447686 | 25.0% | 25 | 1.86119216 | 2.185740307 | 4.04693246 |
| 95 | 0.24298 | 0.056358387 | 25.0% | 25 | 1.40895969 | 1.808929881 | 3.21788957 |
| 96 | 0.25732 | 0.041856247 | 25.0% | 25 | 1.04640618 | 1.450214026 | 2.49662021 |
| 97 | 0.27249 | 0.030450838 | 25.0% | 25 | 0.76127096 | 1.14054088 | 1.90181184 |
| 98 | 0.28855 | 0.021664249 | 25.0% | 25 | 0.54160622 | 0.878658942 | 1.42026517 |
| 99 | 0.30555 | 0.015044738 | 25.0% | 25 | 0.37611844 | 0.661951127 | 1.03806957 |
| 100 | 0.32354 | 0.010177163 | 25.0% | 25 | 0.25442908 | 0.486757444 | 0.74118653 |
| 101 | 0.34258 | 0.006690671 | 25.0% | 25 | 0.16726677 | 0.348649259 | 0.51591603 |
| 102 | 0.36274 | 0.004263697 | 25.0% | 25 | 0.10659242 | 0.242697388 | 0.34928981 |
| 103 | 0.38406 | 0.002626181 | 25.0% | 25 | 0.06565454 | 0.163751539 | 0.22940607 |
| 104 | 0.40663 | 0.001558297 | 25.0% | 25 | 0.03895743 | 0.106788414 | 0.14574585 |
| 105 | 0.43021 | 0.000887902 | 25.0% | 25 | 0.02219755 | 0.067039506 | 0.08923706 |
| 106 | 0.45516 | 0.000483765 | 25.0% | 25 | 0.01209412 | 0.040413756 | 0.05250787 |
| 107 | 0.48156 | 0.000250803 | 25.0% | 25 | 0.00627007 | 0.02329617 | 0.02956624 |
| 108 | 0.50949 | 0.000123021 | 25.0% | 25 | 0.00307553 | 0.012778159 | 0.01585369 |
| 109 | 0.53905 | 5.67067E−05 | 25.0% | 25 | 0.00141767 | 0.006631466 | 0.00804913 |
| 110 | 0.57031 | 2.43663E−05 | 25.0% | 25 | 0.00060916 | 0.003234039 | 0.0038432 |
| 111 | 0.60339 | 9.66392E−06 | 25.0% | 25 | 0.0002416 | 0.001470238 | 0.00171184 |
| 112 | 0.63838 | 3.49467E−06 | 25.0% | 25 | 8.7367E−05 | 0.000616925 | 0.00070429 |
| 113 | 0.67541 | 1.13433E−06 | 25.0% | 25 | 2.8358E−05 | 0.000236033 | 0.00026439 |
| 114 | 0.71458 | 3.23761E−07 | 25.0% | 25 | 8.094E−06 | 8.10572E−05 | 8.9151E−05 |
| 115 | 0.75603 | 7.89881E−08 | 25.0% | 25 | 1.9747E−06 | 2.44773E−05 | 2.6452E−05 |
| 116 | 0.79988 | 1.58071E−08 | 25.0% | 25 | 3.9518E−07 | 6.3181E−06 | 6.7133E−06 |
| 117 | 0.84627 | 2.43002E−09 | 25.0% | 25 | 6.0751E−08 | 1.33771E−06 | 1.3985E−06 |
| 118 | 0.89536 | 2.54278E−10 | 25.0% | 25 | 6.3569E−09 | 2.17575E−07 | 2.2393E−07 |
| 119 | 0.94729 | 1.3403E−11 | 25.0% | 25 | 3.3507E−10 | 2.40875E−08 | 2.4423E−08 |
| 120 | 1 | 0 | 25.0% | 25 | 0 | 1.3403E−09 | 1.3403E−09 |

As can be seen, the structure of the BIRA CD achieves the simultaneous goals of providing annuitization type benefits to the depositor and a reasonable expected cost of liabilities to the issuer together with an FDIC guaranty of principal and interest up to $100,000 per depositor per bank.

With respect to annuitization benefits, the BIRA CD generally provides an increasing internal rate of return with increased age. For example, Table 5 below sets forth the internal rates of return of the BIRA assuming a depositor originally aged 55 dies at the ages indicated. As can be seen in Table 5, the IRR increases with increasing longevity.

TABLE 5

| EOY | Surv. |
|---|---|
| Age | IRR |
| 60 | 1.000% |
| 65 | 1.482% |
| 70 | 1.936% |
| 75 | 2.918% |
| 80 | 3.782% |
| 85 | 4.621% |
| 90 | 5.305% |
| 95 | 5.825% |
| 100 | 6.137% |

The expected liability cost to the issuing bank or thrift can be computed using column 8 from Table 4 above assuming an issuance of 100 dollars at time zero. The expected IRR is equal to 4.38%, providing a reasonable cost of funds to the bank for issuing the BIRA CD. In particular, the bank will find the long term nature of the funding derived from the BIRA CD favorable.

In a preferred embodiment of the BIRA CD, the issuing bank or thrift might be able to pay enhanced rates of interest based upon the assumption that depositors who enter the BIRA loyalty program at time zero will leave the program for reasons other than death, i.e., some depositors still alive will not renew or lapse from the program. For example, assuming a 1% lapse rate during the first 15 years and none thereafter without changing the interest rates offered on the BIRA CD, the expected IRR to the issuing bank can be reduced from 4.38% to 3.73%. Thus, the issuing bank or thrift can afford to increase the rates of interest in the loyalty phase or benefits phase or both based upon lapse assumptions.

The loyalty phase credits can be earned by a customer who has existing deposits in low yielding “core deposit” instruments such as checking or savings accounts. The dollar amounts in the loyalty phase and benefits phase can be changed so that a smaller amount of dollars is required to remain at the bank during the benefits phase. For example, the depositor would be indifferent in the above example, between receiving interest of 10% on $100 invested and 100% interest on $10 invested. The depositor may be able then, once the loyalty phase ends and the benefits phase begins, to obtain a return of principal of $90. This return of principal is not taxable income and therefore may be preferred by a depositor. Different schedules of rates and principal amounts in the loyalty and benefits periods are possible to achieve the dual goals of annuitization (increasing IRR with age) and reasonable liability cost to the issuing bank or thrift.

### Variable Universal Life Wrapped Immediate Annuity Method

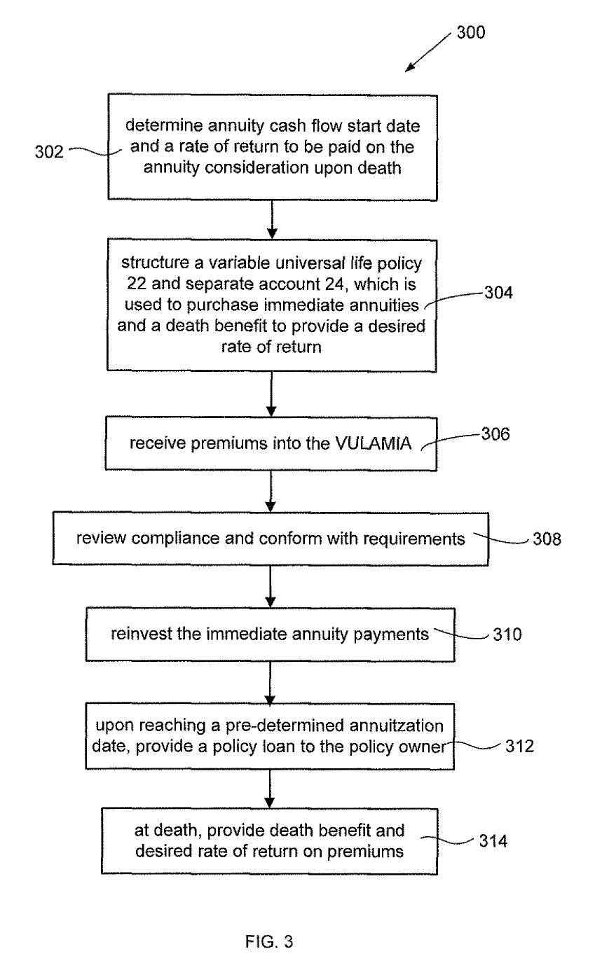

Referring to FIG. 3, another flowchart representing a method for the creation of a variable universal life anti-martingale immediate annuity (VULAMIA) product is shown and referred to generally by the reference numeral 300. A VULAMIA account is also shown in FIG. 1 and referred to generally by the reference numeral 20. The flow charts herein illustrate the structure or the logic of the present technology, possibly as embodied in computer program software for execution on a computer, digital processor or microprocessor. Those skilled in the art will appreciate that the flow charts illustrate the structures of the computer program code elements, including logic circuits on an integrated circuit, that function according to the present technology. As such, the present technology may be practiced by a machine component that renders the program code elements in a form that instructs a digital processing apparatus (e.g., computer) to perform a sequence of function steps corresponding to those shown in the flow charts.

A problem with currently offered immediate annuities is that a large portion of the immediate annuity payment is taxable in the years prior to the annuitant's life expectancy and fully taxable thereafter. Another disadvantage with state of the art immediate income annuities is that the cost of features which reduce the full loss of a life only income annuity is very high. For example, on a 45 year old male, an exemplary life income annuity on Apr. 24, 2008 paid an annual income at a rate of 6.65% of which 40% is taxable until the basis is recovered, after which the entire annual payment is taxable at ordinary income rates. Upon death, the payments stop so an early death exposes the purchaser to potential loss.

An option can be added to provide a lump sum refund up to the purchase price not received upon early death (at this rate, a death in the first 15 years or so will leave some amount of the purchase price unrecovered), but at a cost. The option to receive this refund reduced the annual payment to 6.49%. The cost of this insurance is very high. For example, a 45 year old male's cost of term insurance for 15 years is only 10 basis points. Effectively, the 16 basis point cost is actually equivalent to 32 basis points of term cost since the cost only covers amounts not yet recouped by the annuitant. Since the amount of early death insurance declines with each passing year, immediate annuities offer attractive economics only in a “binary” form where there is a loss of some unrecovered principal upon death. There is currently no product that allows the immediate annuity customer to “dial in” a rate of return upon annuitization to be balanced against a rate of return received upon death.

Another problem with current state of the art immediate annuities is that, by law, the annuity payments must start within 12 months of the purchase date. Such a restriction makes it difficult for those desiring much greater payments in the future to obtain a stronger form of longevity insurance, whereby future life income payments begin years rather than months into the future and where such payments can economically be made much larger by the insurance company.

The flowchart 300 of FIG. 3 shows a method for creating an annuitization product called the variable universal life anti-martingale immediate annuity (VULAMIA), which overcomes many of these and other obstacles. At step 302, the method solicits the preference from the annuitant for annuity income and the timing of such income versus the risks of loss of annuity purchase price from early death. Based on the preferences, the method determines a desired annuity cashflow start date and a rate of return to be paid on the annuity consideration upon death.

At step 304, the method structures a variable universal life policy identified by reference numeral 22 in FIG. 1. In addition to the variable universal life policy 22, a separate account, identified by reference numeral 24 in FIG. 1, is established to purchase immediate annuities and a death benefit. Thus, the separate account 24 provides the desired rate of return on premium paid into the variable universal life policy 22 to purchase the annuities.

Still referring to FIG. 3, at step 306, the method receives premium payments into the VULAMIA account 20. The VULAMIA account 20 optimizes the amount and cost of the death benefit versus the timing of the purchase of the immediate annuities in the separate account. The objective function is to maximize the amount of lifetime after tax income the owner of the VULAMIA can attain at any given annuitization age. The annuitization age is the age at which the payee under the contract will start receiving annutization payments from the VULAMIA in the form of tax-free policy loans made available from annuity cashflows inside the variable universal life separate account. The optimization is a function of: (1) the age of the annuitant; (2) the health status of the annuitant (whether the annuitant might be a candidate for a higher rate impaired immediate annuity); (3) expected future interest rates and forward rates implied by the market; and (4) future cost of insurance rates for the net amount at risk on the death benefit of the VULAMIA as well as other factors. For example, if the probability of rates going up prior to the annuitization date is high and the probability of the annuitant qualifying for an impaired risk annuity is high, then it will be more optimal to wait to purchase additional immediate annuities. Conversely, if rates are expected to go down, it may be optimal to purchase a large amount of immediate annuities early and reinvest all immediate annuity payments through to the annutization date. Exact solutions based upon the preceding inputs can be obtained using techniques such as dynamic programming.

At step 308, the method reviews applicable laws and seeks compliance. For example, it may be required to diversify the products within the separate annuity account 24. If so, the method may purchase at least five annuities from different third-party companies with the initial premium such that the purchases of the five annuities satisfy the applicable legal requirements for diversification.

At step 310, the method reinvests each received immediate annuity payment until the desired payout date is reached and pays the cost of insurance on the net amount at risk of the VULAMIA account 20. The owner/annuitant may also be able to obtain a policy loan at low net cost.

At step 312, upon reaching the desired annuitization date, the method provides policy loans to the policy owner.

At step 314, at death of the owner/annuitant, the method provides the death benefit and desired rate of return on premiums.

In a preferred embodiment, immediate annuities are purchases inside the separate account 24 of the variable life insurance policy 22. That is, the variable life insurance policy 22 is used as a “wrapper” for the purchase of immediate annuities. Such a wrapper eliminates all taxation of the annuity cash flows when received, allows annuity cashflows received to be reinvested efficiently and without taxation, allows for a lower cost death benefit to be supplied, and provides an efficient separate account vehicle for the immediate annuities to be purchases using an anti-martingale strategy over time.

In a preferred embodiment, the immediate annuities are purchased using an anti-martingale strategy (AMS). For example, assume that five premium payments are put in the VULAMIA of $20,000 each in each of the first five years. With receipt of each premium payment, the cost of insurance for the death benefit is first subtracted. The balance is available to the separate account for purchase of immediate annuities. If regulation is applicable, the method complies with the regulation. For example, the annuities can be purchased to satisfy a diversification requirement say for example as required by the Internal Revenue Code.

In another preferred embodiment, the annuities are purchased with a monthly payment frequency. In one preferred embodiment, each annuity is scheduled to start making payments in 12 months. When each monthly payment is received, the respective payment is immediately invested in another new immediate annuity, less the amount required to cover that month's cost of insurance for the death benefit on the variable life policy wrapper. Surviving when one owns an annuity is a good outcome or amounts to “winning” each period that one survives. Upon the measured life's survival of each annuity period, more annuities are purchased. Since the measured life is older at each purchase date, the immediate annuity rate is higher. Because, more is “bet”, as long as each “bet” is won, an applicable strategy name is the anti-martingale strategy. In short, buying immediate annuities at higher rates as one ages with each immediate annuity coupon received is called the anti-martingale strategy for immediate annuities.

### Example 1

### VULAMIA

Below is an example illustrating a data set for a VULAMIA product in accordance with the subject technology. Table 6 below is based on the assumption that the market rate for immediate annuities pays the following for each male age, where the amounts are in dollars per month per $100,000 purchased.

TABLE 6

| Age | Amount per 100k |
|---|---|
| 40 | $517.33 |
| 45 | $543.05 |
| 50 | $575.05 |
| 55 | $615.61 |
| 60 | $662.63 |
| 65 | $737.04 |
| 70 | $822.73 |
| 75 | $959.74 |
| 80 | $1,136.37 |
| 85 | $1,398.72 |
| 90 | $1,579.90 |

In this example, a 40 year old pays five equal annual premiums of $20,000 into the VULAMIA as indicated in Table 7 below.

TABLE 7

| Year | Month | Premium |
|---|---|---|
| 1 | 12 | $20,000 |
| 2 | 24 | $20,000 |
| 3 | 36 | $20,000 |
| 4 | 48 | $20,000 |
| 5 | 60 | $20,000 |

Assume further that the payee desired a 3% return upon death of the premiums paid and that the variable universal life policy (VUL) 22 being used as a wrapper is to be made compliant with any applicable regulations. For example, the VUL wrapper is compliant with the requirement of applicable regulations and rules such. The VUL wrapper also may be issued as a non-MEC (“non-Modified Endowment Contract”). At the time of filing the subject patent application, the rules in the Internal Revenue Code (IRC) respecting Modified Endowment Contracts (MEC) were codified in 26 Section 7702A. A life insurance policy which complies with the MEC rules is considered to be a non-MEC, which entitled that contract to more favorable tax treatment than a MEC. The two primary advantages to being a non-MEC are (1) amounts can be withdrawn from cash accumulation value up the policy owner's basis free of tax; and (2) amounts distributed in the form of policy loans are free of tax. Under the rules embodied in 7702A, a MEC arises if the volume of premiums relative to the death benefit is too large over a given time frame, such as the first 7 years of the contract. The minimum death benefit that satisfied both these rules under allowable calculation methods but that also satisfied the 3% return on premium (effectively, the higher of the tax code compliant death benefit and the 3% return on premium) is contained in Table 8 below.

TABLE 8

| Age | DB |
|---|---|
| 41 | $533,528 |
| 42 | $533,528 |
| 43 | $533,528 |
| 44 | $533,528 |
| 45 | $533,528 |
| 46 | $533,528 |
| 47 | $533,528 |
| 48 | $533,528 |
| 49 | $533,528 |
| 50 | $533,528 |
| 51 | $533,528 |
| 52 | $301,030 |
| 53 | $288,039 |
| 54 | $292,371 |
| 55 | $296,566 |
| 56 | $299,981 |
| 57 | $309,484 |
| 58 | $319,428 |
| 59 | $329,816 |
| 60 | $340,651 |
| 61 | $349,420 |
| 62 | $364,248 |
| 63 | $380,374 |
| 64 | $397,896 |
| 65 | $416,927 |
| 66 | $436,443 |
| 67 | $461,536 |
| 68 | $489,147 |
| 69 | $519,536 |
| 70 | $552,995 |
| 71 | $583,624 |
| 72 | $612,283 |
| 73 | $644,657 |
| 74 | $681,132 |
| 75 | $722,173 |
| 76 | $762,995 |
| 77 | $825,126 |
| 78 | $896,831 |
| 79 | $979,636 |
| 80 | $1,075,377 |
| 81 | $1,171,560 |
| 82 | $1,284,793 |
| 83 | $1,419,941 |
| 84 | $1,581,453 |
| 85 | $1,774,898 |
| 86 | $2,026,401 |
| 87 | $2,327,550 |
| 88 | $2,687,053 |
| 89 | $3,117,925 |
| 90 | $3,636,424 |
| 91 | $4,344,445 |
| 92 | $5,153,463 |
| 93 | $5,502,564 |
| 94 | $5,449,141 |
| 95 | $5,395,718 |
| 96 | $5,342,295 |
| 97 | $5,342,295 |
| 98 | $5,342,295 |
| 99 | $5,342,295 |
| 100 | $5,342,295 |

At the beginning of the contract for the VULAMIA (“time zero”), the first $20,000 premium is paid. After paying the cost of insurance (“COI”), which in this example is approximately $18.00 per month for the balance of the $20,000 (not used to pay premium tax, and mortality and expense fees), a portion of the balance is used to purchase at least five single premium immediate annuities (SPIAS). In a preferred embodiment, each annuity is purchased from a different insurance company. The SPIAS are owned in the variable life insurance policy's separate account 24.

In a preferred embodiment, each SPIA has a monthly payment frequency. One or more of the SPIA may begin paying twelve months from the date of purchase. As each monthly payment is received, the payment is used to purchase another SPIA. Purchases should be made so diversification requirements and any other regulatory requirements, as applicable, are met. The SPIA payments therefore compound at a rate equal to the then current SPIA rate at reinvestment, which will increase each month with age, all else equal, and after deducting for that month's cost of insurance.

For example, after anti-martingaling the SPIAS for 40 years, at age 80 the annual cashflow produced by the five $20,000 initial premium payments is equal to $140,775. The owner/payee may then make policy loans at this point equal to this amount less the then current cost of insurance without having to pay income tax. Thus, in a preferred embodiment, the VULAMIA produces a substantial and tax efficient form of retirement income. In particular, the VULAMIA of the present technology is a very efficient form of longevity insurance.

Assume the SPIAS are allowed to anti-martingale until age 85. At that point, the annual cashflow than can be received using tax-free loans is equal to $286,552. The result is a longevity insurance product with cashflow, high credit quality and no income tax. Typical, longevity insurance products are simply a variable annuity. One problem with variable annuities is that a variable annuity has cashflows which are fully taxable at ordinary rates in excess of basis. Another problem is that the returns do not compound at the higher SPIA rates since the SPIA rates include a mortality premium.

In a preferred embodiment, an algorithm performed on a special purpose computer is used to determine the amount of VULAMIA cashflow that can be received at a later age starting from an initial age. The result for one example is as shown in Table 9 below.

TABLE 9

| | Months | Rate | | | | 5 yr inc | Annual | |
|---|---|---|---|---|---|---|---|---|
| Age | Fwd | (bps mo) | Exclusion | Mart | ratio | val | rate | Ann pay |
| 40 | 12 | 0.0051733 | 100.00% | 0.0855% | 0.165206 | | | |
| 45 | 72 | 0.0054305 | 100.00% | 0.6069% | 1.117567 | | 7.3% | $7,283 |
| 50 | 132 | 0.0057505 | 100.00% | 0.8306% | 1.444406 | 5.26% | 10.0% | $9,967 |
| 55 | 192 | 0.0061561 | 100.00% | 1.1685% | 1.898159 | 5.62% | 14.0% | $14,022 |
| 60 | 252 | 0.00662625 | 100.00% | 1.6933% | 2.555381 | 6.13% | 20.3% | $20,319 |
| 65 | 312 | 0.00737035 | 100.00% | 2.5322% | 3.435647 | 6.10% | 30.4% | $30,386 |
| 70 | 372 | 0.0082273 | 100.00% | 3.9457% | 4.795842 | 6.90% | 47.3% | $47,348 |
| 75 | 432 | 0.00959735 | 100.00% | 6.5201% | 6.793675 | 7.21% | 78.2% | $78,242 |
| 80 | 492 | 0.0113637 | 100.00% | 11.7312% | 10.32342 | 8.73% | 140.8% | $140,775 |
| 85 | 552 | 0.0139872 | 100.00% | 23.8793% | 17.07225 | 10.58% | 286.6% | $286,552 |
| 90 | 612 | 0.015799 | 100.00% | 55.4327% | 35.08622 | 15.50% | 665.2% | $665,193 |
| 95 | 672 | 0.015799 | 100.00% | 136.9675% | 86.6938 | 19.83% | 1643.6% | $1,643,610 |

| | |
|---|---|
| Invest | $100,000 |
| Term Cost | 6.36% |
| eq rate | |
| retirement yr | 85 |
| 30 yr | 4.388% |
| Eq spread | 1.975% |
| spia comm | 4.00% |
| npv comm | $13,645.36 |
| NPV comm % | 13.645% |
| Linear per year | 0.3032% |
| Rate on DB | 3.0% |
| Min nonMEC | N |
| START AGE | 40 |
| Rate UP Age | 0 (60 or less) |
| Rate Up Yrs | 0 (6 or less) |

| Tax Free Pmt | Year | Month | Premium |
|---|---|---|---|
| $286,551.51 | 1 | 12 | $20,000 |
| | 2 | 24 | $20,000 |
| | 3 | 36 | $20,000 |
| | 4 | 48 | $20,000 |
| | 5 | 60 | $20,000 |
| | | 1000 | 0 |

In view of the current disclosure, it can be seen that VULAMIA account 20 has many advantages including that the VULAMIA customer may not be charged any fees. The company issuing the VULAMIA account 20 is fully compensated by the commissions earned from purchasing other companies' SPIA contracts into the customer's separate account. Thus, in a preferred embodiment, the issuing company of the VULAMIA account 20 should have at least one insurance producer who is licensed and can receive such commissions.

Another advantage is that the VULAMIA measured life will provide a lifetime medical records consent to the VULAMIA contract issuer. Periodically, the issuer can determine whether the measured life has suffered a deterioration in health which might merit application for a rated up SPIA. Such a SPIA would pay a higher rate than a SPIA which is not rated up for medical reasons. Active management of the state of the health of the measured life can substantially increase the returns of the VULAMIA account 20 over time.

In the preceding specification, the present disclosure has been described with reference to specific exemplary embodiments thereof. Although many steps have been conveniently illustrated as described in a sequential manner, it will be appreciated that steps may be reordered or performed in parallel. It will further be evident that various modifications and changes may be made therewith out departing from the broader spirit and scope of the present disclosure as set forth in the claims that follow. The description and drawings are accordingly to be regarded in an illustrative rather than a restrictive sense. Those skilled in the art will readily appreciate that various changes and/or modifications can be made to the invention without departing from the spirit or scope of the invention as defined by the appended claims.

What is claimed is:

1. A method for creating a bank issued replicated annuity (BIRA) certificate of deposit (CD) comprising the steps of:
receiving a plurality of deposits from a depositor over a loyalty period;
during the loyalty period, storing the deposits at a first savings rate and accrediting the depositor loyalty points based on an amount of the deposits; and
during a benefit period subsequent to the loyalty period, storing the deposits at a second savings rate, wherein the second saving rate is higher than the first saving rate.

2. A method as recited in claim 1, wherein the first savings rate is below market and the second saving rate is above market.

3. A method as recited in claim 1, wherein the first and second savings rates are based on the loyalty points.

4. A method as recited in claim 1, wherein the loyalty period is 15 years, the benefits period is year 16 and above, the savings rate is 1% for years 1 through 5, the savings rate is 2% for years 6 through 10, the savings rate is 3% for years 11 through 15, the savings rate is 7% for years 16 through 20, and 10% for years 21 through 25.

5. A method as recited in claim 1, wherein the first and second savings rates increase periodically.

6. A method as recited in claim 1, further comprising the step of converting the deposits to an annually renewable time certificate of deposit at a beginning of the benefits period.

7. A method as recited in claim 6, wherein the annually renewable time certificate of deposit has a put option payable at a death of the depositor.

8. A method as recited in claim 7, further comprising the step of paying an enhanced second savings rate based upon lapse assumptions.

9. A method as recited in claim 1, wherein the loyalty points are basis points computed as a function of a difference between a market interest rate and the first savings rate.

10. A computer-readable medium whose contents cause a financial system to perform a method for creating a longevity insurance product, wherein the longevity insurance product provides cashflow, high credit quality and no income tax, the financial system having a digital signal processor and a program with functions for invocation by performing the steps of:
soliciting preferences from an annuitant for annuity income and timing of the annuity income versus a risk of loss of an annuity purchase price from early death of the annuitant;
determining an annuity cashflow start date and a rate of return to be paid on an annuity consideration premium upon death based on the preferences;
structuring a variable universal life policy to act as a wrapper for a separate account, wherein the separate account is used to purchase immediate annuities and a death benefit which provides the rate of return on the annuity consideration premium;
receiving premium payments into a variable universal life anti-martingale immediate annuity (VULAMIA) to purchase the variable universal life policy and the immediate annuities;
reinvesting immediate annuity payments until a predetermined payout date; and
at death of the annuitant, providing a death benefit and the predetermined rate of return on the annuity consideration premiums.

11. A computer-readable medium as recited in claim 10, further comprising the step of providing policy loans to the annuitant upon reaching the annuity cashflow start date.

12. A computer-readable medium as recited in claim 10, wherein the immediate annuities are purchased from a plurality of sources.

13. A computer-readable medium as recited in claim 12, wherein the immediate annuities are purchased by buying immediate annuities at higher rates as the annuitant ages with each immediate annuity coupon received.

14. A computer-readable medium as recited in claim 13, wherein the immediate annuities are purchased monthly, wherein each monthly payment is invested in another new immediate annuity, less an amount required to cover that month's cost of insurance for the death benefit.

15. A computer-readable medium as recited in claim 10, wherein a portion of the balance is used to purchase at least five single premium immediate annuities, each annuity is purchased from a different insurance company.

16. A computer-readable medium as recited in claim 10, further comprising the step of computing an amount of VULAMIA cashflow on a year by year basis.

17. A computer-readable medium as recited in claim 10, further comprising the step of compensating a first company issuing the VULAMIA by commissions earned from purchasing at least one other company SPIA contracts into the separate account.

18. A computer-readable medium as recited in claim 17, further comprising the step of acquiring a lifetime medical records consent from the annuitant to the first company.

19. A computer-readable medium as recited in claim 18, further comprising the step of periodically determining whether a measured life of the annuitant has suffered a deterioration in health which might merit application for a rated up SPIA.

20. A method of creating a variable universal life anti-martingale immediate annuity (VULAMIA) comprising the steps of:
soliciting preferences from an annuitant for annuity income and timing of the annuity income versus a risk of loss of an annuity purchase price from early death of the annuitant;
determining an annuity cashflow start date and a rate of return to be paid on an annuity consideration premium upon death based on the preferences;
structuring a variable universal life policy to act as a wrapper for a separate account, wherein the separate account is used to purchase immediate annuities and a death benefit which provides the rate of return on the annuity consideration premium;
receiving premium payments into a VULAMIA to purchase the variable universal life policy and the immediate annuities;
reinvesting immediate annuity payments until a predetermined payout date; and
at death of the annuitant, providing a death benefit and the predetermined rate of return on the annuity consideration premiums.
